(19) United States
(12) Patent Application Publication
(10) Pub. No.: US 2021/0271383 A1
(43) Pub. Date: Sep. 2, 2021

(54) PICTURE DISPLAYING METHOD, ELECTRONIC DEVICE AND STORAGE MEDIUM

(71) Applicant: ZHANGYUE TECHNOLOGY CO., LTD, Beijing (CN)

(72) Inventors: Shubin YANG, Beijing (CN); Wangming QI, Beijing (CN)

(21) Appl. No.: 17/254,011

(22) PCT Filed: Jan. 31, 2019
(86) PCT No.: PCT/CN2019/074172

§ 371 Date: Dec. 18, 2020

(30) Foreign Application Priority Data
Jun. 29, 2018 (CN) 201810698620.5

(51) Int. Cl. G06F 3/0488; G06F 3/0484; G06F 3/0483

(52) U.S. Cl. CPC G06F 3/04883; G06F 3/0483; G06F 3/04845

(57) ABSTRACT

Disclosed are a picture displaying method, an electronic device and a storage medium. The picture display method includes: receiving an event of triggering a movement of the picture, wherein the picture includes a plurality of picture elements displayed on a plurality of layers, respectively; acquiring at least one movement parameter corresponding to each of the plurality of layers based on the event, wherein at least one movement parameter corresponding to at least one of the plurality of layers differs from at least one movement parameter corresponding to any other layer among the plurality of layers; and generating the plurality of picture elements on the plurality of layers based on a plurality of movement parameters corresponding to the plurality of layers, respectively, in response to the event.

### CROSS REFERENCE TO RELATED APPLICATION

This application is based upon and claims priority to Chinese Patent Application NO.201810698620.5, titled “PICTURE DISPLAYING METHOD, ELECTRONIC DEVICE AND STORAGE MEDIUM”, filed Jun. 29, 2018, the entire contents of which are incorporated herein by reference.

### TECHNICAL FIELD

The disclosure relates to the technical field of picture processing, and in particular to a picture displaying method, an electronic device and a storage medium.

### BACKGROUND

The electronic book has the advantages of easy carrying and access, and is popular for more and more users. The most of users are used to downloading and reading the electronic book by using an electronic book client installed in a terminal device. In order to help the users to know the electronic book, reading activities or member account recharge activities in the electronic book client, banner positions are generally provided at top of a first page or some main pages. Pictures for promoting various content or activities are displayed circularly to the users at the banner positions, expecting the users to see the above content firstly.

In the prior art, there are multiple pictures for displaying at the banner positions. The users may switch from a picture currently displayed into a next picture by a sliding operation. If there is no gesture operation from the users, pictures for displaying are switched by carousel at the banner positions. However, in the prior art, pictures for displaying at the banner positions are all static pictures which are switched simply from one picture into another picture on the visual effects, resulting in that the picture display effect is monotone and the content promotion effect is poor.

### SUMMARY

In view of above, a picture displaying method, an electronic device and a storage medium are provided according to the present disclosure, to solve the above problems or at least partially solve the above problems.

According to an aspect of the present disclosure, a picture displaying method is provided. The picture includes a plurality of picture elements displayed on a plurality of layers, respectively. The method includes:

receiving an event of triggering a movement of the picture;

acquiring at least one movement parameter corresponding to each of the plurality of layers based on the event, wherein at least one movement parameter corresponding to at least one of the plurality of layers differs from at least one movement parameter corresponding to any other layer among the plurality of layers; and

generating the plurality of picture elements on the plurality of layers based on a plurality of movement parameters corresponding to the plurality of layers, respectively, in response to the event.

According to another aspect of the present disclosure, an electronic device is provided. The electronic device includes: at least one processor; and at least one memory, the at least one memory storing executable instructions that upon execution cause the at least one processor to perform operations, the operations comprising:

receiving an event of triggering a movement of the picture;

acquiring at least one movement parameter corresponding to each of the plurality of layers based on the event, wherein at least one movement parameter corresponding to at least one of the plurality of layers differs from at least one movement parameter corresponding to any other layer among the plurality of layers; and

generating the plurality of picture elements on the plurality of layers based on a plurality of movement parameters corresponding to the plurality of layers, respectively, in response to the event.

According to further another aspect of the present disclosure, a non-volatile computer-readable storage medium is provided, in which at least one executable instruction is stored, wherein the executable instruction is configured to cause a processor to execute operations, the operations comprising:

receiving an event of triggering a movement of the picture;

acquiring at least one movement parameter corresponding to each of the plurality of layers based on the event, wherein at least one movement parameter corresponding to at least one of the plurality of layers differs from at least one movement parameter corresponding to any other layer among the plurality of layers; and

generating the plurality of picture elements on the plurality of layers based on a plurality of movement parameters corresponding to the plurality of layers, respectively, in response to the event.

According to yet another aspect of the present disclosure, a computer program product is further provided, which includes a computing program stored on the above described non-volatile computer-readable storage medium.

With the picture displaying method according to the embodiment, a plurality of picture elements of the picture are displayed on a plurality of layers respectively. At least one movement parameter corresponding to at least one of the plurality of layer differs from at least one movement parameter corresponding to any other layer among the plurality of layers. After the event for moving the picture is received, the plurality of picture elements are generated on the plurality of layers correspondingly based on a plurality of movement parameters corresponding to the plurality of layers, so that the pictures are displayed in a staggered manner and a movement effect of the picture is greatly enriched, thereby being beneficial to attract attention of the user and thus effectively improving promotional effect of content.

The summary of the technical solutions of the present disclosure is described above. The technical means of the present disclosure may be understood clearer according to content of the specification. In order to make the above and other objects, features and advantages of the present disclosure clearer and easier to be understood, specific embodiments of the present disclosure are described hereinafter.

### BRIEF DESCRIPTION OF THE DRAWINGS

According to the detailed description of preferred embodiments of the present disclosure, various other advantages and benefits become clear for those skilled in the art. Drawings are only used to illustrate the preferred embodiments rather than limit the present disclosure. Throughout the drawings, the same components are represented by the same reference numeral. In the drawings:

FIG. 1 is a schematic flowchart of a picture displaying method according to a first embodiment of the present disclosure;

FIG. 2a is a schematic flowchart of a picture displaying method according to a second embodiment of the present disclosure;

FIG. 2b is a schematic diagram showing initial displaying of picture 1 in an electronic book client;

FIG. 2c is a schematic diagram of displaying of the picture 1 in the electronic book client;

FIG. 3a is a schematic flowchart of a picture displaying method according to a third embodiment of the present disclosure;

FIG. 3b is a schematic diagram of a display region corresponding to display position of a picture main scenario element 20 to be displayed on a second layer for the picture 1, and a movement range corresponding to the second layer;

FIG. 3c is a schematic diagram of another displaying of the picture 1 in the electronic book client; and

FIG. 4 is a schematic structural diagram of an electronic device according to a fifth embodiment of the present disclosure.

### DETAILED DESCRIPTION

Schematic embodiments of the present disclosure are described in detail with reference to the drawings hereinafter. Although the drawings show the schematic embodiments of the present disclosure, it should be understood that the present disclosure may be implemented by various embodiments and is not limited by embodiments clarified herein. Practically, the embodiments are described herein so that the present disclosure can be understood thoroughly and the scope of the present disclosure can be completely conveyed to those skilled in the art.

### First Embodiment

FIG. 1 is a schematic flowchart of a picture displaying method according to a first embodiment of the present disclosure. The method includes steps S101 to S103 in the following.

Step S101, receiving an event of triggering a movement of the picture.

An electronic book client is installed in a terminal device. The terminal device may be a mobile phone, a PAD, an electronic book reader and so on. A user may download and read the electronic book through the electronic book client. In order to facilitate knowing the electronic book, reading activities or member account top-up activities in the electronic book client by the user, multiple banner pictures are generally displayed circularly at a position such as the top and the middle of a main page of the electronic book client. In the present disclosure, a banner picture includes a plurality of picture elements displayed on a plurality of layers respectively. The picture can be moved in response to a sliding gesture of the user or carousel. In step S101, an event of triggering a movement of the picture is received.

Specifically, the picture may include a picture background element, a picture main scenario element, a picture text element and so on, and a plurality of picture elements are respectively displayed on a plurality of layers. Those skilled in the art may set the number of the layers, content of a plurality of picture elements and the initial display position information as needed, which are not limited herein.

Step S102, acquiring at least one movement parameter corresponding to each of the plurality of layers based on the event.

After the event is received, at least one movement parameter corresponding to each of the plurality of layers are acquired from layer configuration information based on the event. At least one movement parameter corresponding to at least one of the plurality of layers differs from at least one movement parameter corresponding to any other layer among the plurality of layers, so that a staggered displaying effect of the picture is obtained. Specifically, the movement parameters corresponding to each layers may be set based on priorities of the layers.

Step S103, generating the plurality of picture elements on the plurality of layers based on a plurality of movement parameters corresponding to the plurality of layers, respectively, in response to the event.

After the movement parameters corresponding to the plurality of layers are acquired, display position of picture elements to be displayed on the plurality of layers respectively is generated based on the movement parameters, in response to the event. Then, based on the generated display position, the plurality of picture elements are generated on the plurality of layers respectively. At least one movement parameter corresponding to at least one of the plurality of layer differs from at least one movement parameter corresponding to any other layer among the plurality of layers, so that the plurality of picture elements have different movement effects after the plurality of picture elements are generated on the plurality of layers respectively, thereby obtaining a picture staggered displaying effect and thus being beneficial to attract the attention of the user.

With the picture displaying method according to the embodiment, a plurality of picture elements of the picture are displayed on a plurality of layers respectively. At least one movement parameter corresponding to at least one of the plurality of layer differs from at least one movement parameter corresponding to any other layer among the plurality of layers. After the event for moving the picture is received, the plurality of picture elements are generated on the plurality of layers correspondingly based on a plurality of movement parameters corresponding to the plurality of layers, so that the pictures are displayed in a staggered manner and a movement effect of the picture is greatly enriched, thereby being beneficial to attract attention of the user and thus effectively improving promotional effect of content.

### Second Embodiment

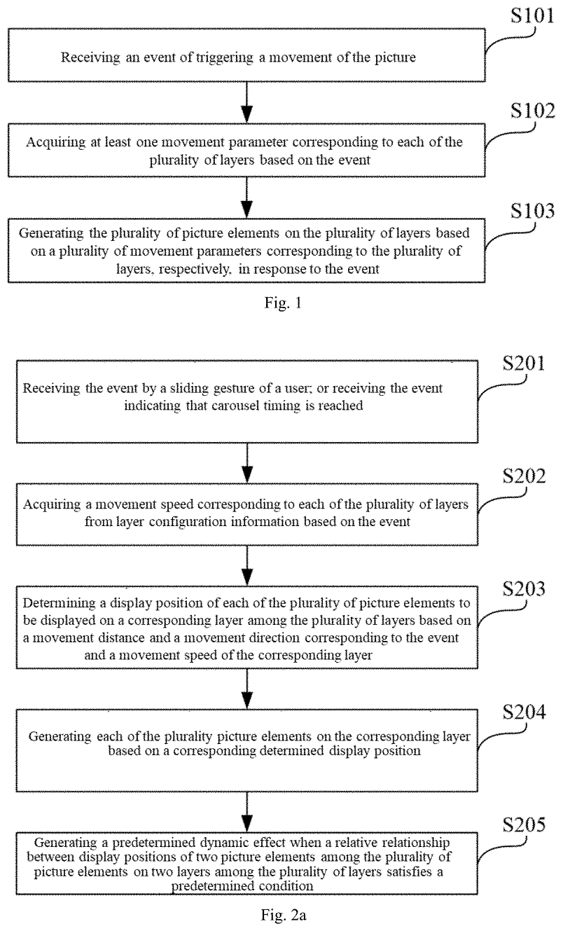

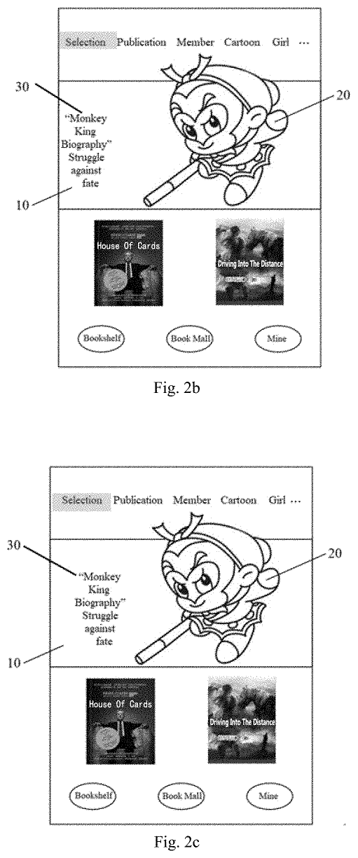

FIG. 2a is a schematic flowchart of a picture displaying method according to a second embodiment of the present disclosure. As shown in FIG. 2a, the method includes steps S201 to S205 in the following.

Step S201, receiving the event by a sliding gesture of a user; or receiving the event indicating that a carousel timing is reached.

Multiple classification pages such as selection, publication, member, cartoon, girls and boys are generally provided in the electronic book client, so that the users can choose the classification page for viewing based on their own preferences. A plurality of pictures which can be displayed circularly are provided at a position of each classification page such as the top of each classification page, to show content in the classification page which is expected to be seen by the user first. Each picture may include at least one of a picture background element displayed on a first layer, a picture main scenario element displayed on a second layer and a picture text element displayed on a third layer. The picture main scenario element is an important picture element of the picture, and a display height of the picture main scenario element may be greater than a display height of the picture background element, so that the picture main scenario element is highlighted to obtain a good stereoscopic display effect, thereby highlighting important content of the picture. Those skilled in the art may set the picture elements included in the picture, specific content of the picture elements and the initial display position as needed, which are not limited herein.

For example, a plurality of pictures which can be displayed circularly are provided at the top of the selection page of the electronic book client. One picture of the plurality of pictures is picture 1 for displaying promotion content of an electronic book “Monkey King Biography”. The picture 1 includes a picture background element 10 displayed on a first layer, a picture main scenario element 20 displayed on a second layer and a picture text element 30 displayed on a third layer. FIG. 2b shows a schematic diagram of initial displaying of the picture 1 in the electronic book client. The picture background element 10 is a white background picture, the picture main scenario element 20 is a cartoon character picture of Monkey King, and the picture text element 30 is a text of ““Monkey King Biography” struggle against fate”. In order to highlight the picture main scenario element 20, a display height of the picture main scenario element 20 may be greater than a display height of the picture background element 10. For example, a head of the cartoon character picture of Monkey King exceeds the white background picture.

The plurality of pictures can be moved in response to a sliding gesture of the user or carousel. When the user wants to move the picture, the user may make a slide gesture towards left or right for the picture on a touch display screen of the terminal device, and thus in step S201, the electronic book client receives a event triggered by the sliding gesture of a user. Alternatively, when the carousel timing is reached, the event is triggered, and thus in step S201, the electronic book client receives the event indicating that a carousel timing is reached. Those skilled in the art may set the carousel timing as needed, which is not limited herein. For example, the carousel timing may be 3 seconds.

Step S202, acquiring a movement speed corresponding to each of the plurality of layers from layer configuration information based on the event.

The layer configuration information includes specific content of picture elements corresponding to each layer, initial display position of the picture element, a movement speed and a movement range, etc. Based on the event, the movement speed corresponding to each layer is acquired from the layer configuration information, so that corresponding picture element is generated on each layer based on the movement speeds corresponding to the plurality of layers respectively. In the embodiment, different layers correspond to a same movement range; and a layer with a higher priority corresponds to a smaller movement speed, so that the picture elements displayed on the layer with the high priority can stay in a visual field of the user for a longer time, thereby attracting more attention of the user.

In an actual application, the priority of the second layer is higher than the priority of the third layer, and the priority of the third layer is higher than the priority of the first layer. Therefore, the movement speed corresponding to the second layer is less than the movement speed corresponding to the third layer and the movement speed corresponding to the third layer is less than the movement speed corresponding to the first layer, so that the main scenario element of the picture displayed on the second layer can stay in the visual field of the user for a longer time, so as to attract attention of the user on the picture main scenario element, thereby realizing the purpose to highlight the picture main scenario element.

Step S203, determining a display position of each of the plurality of picture elements to be displayed on a corresponding layer among the plurality of layers based on a movement distance and a movement direction corresponding to the event and a movement speed of the corresponding layer.

Specifically, based on the movement distance and the movement direction corresponding to the event and the movement speed of each layer, a movement distance in a movement direction corresponding to the event of picture elements to be displayed on each layer is determined first. Then, display position of picture elements to be displayed on each layer is determined based on the movement distance of the picture elements to be displayed on each layer and initial display position of the picture elements. A layer with a higher priority corresponds to a smaller movement speed. For the layer with higher priority, the movement distance of the picture elements to be displayed is smaller.

Step S204, generating the plurality of picture elements on the plurality of layers based on the determined display position of each of the plurality of picture elements to be displayed on a corresponding layer among the plurality of layers.

After the display position of each of the plurality of picture elements to be displayed on a corresponding layer among the plurality of layers is determined, the plurality of picture elements on the plurality of layers are generated respectively based on the display position of each of the plurality of picture elements to be displayed on a corresponding layer among the plurality of layers. Specifically, corresponding picture element is generated in a display region corresponding to the display position in each of the plurality of the layer. If the movement direction corresponding to the event is towards right, a schematic diagram of displaying of the generated picture 1 is shown in FIG. 2c.

Since the respective layers corresponds to different movement speeds, display regions of picture elements of different layers may overlap with each other. In a case that the display regions of the picture elements of any two layers overlap with each other, picture elements of a layer with a higher priority are generated above the picture element of a layer with a lower priority, thereby displaying the picture elements of the layer with the higher priority to the user.

Step S205, generating a predetermined dynamic effect when a relative relationship between display positions of two picture elements among the plurality of picture elements on two layers among the plurality of layers satisfies a predetermined condition.

In order to further enrich a picture display effect, a relative relationship between display positions of picture elements on two layers among the plurality of layers is determined based on display positions of the picture elements to be displayed on the two layers. Then, a predetermined dynamic effect is generated in a case that the relative relationship between display positions of the picture elements satisfies a predetermined condition. Those skilled in the art may set the predetermined condition and the predetermined dynamic effect as needed, which are not limited herein. For example, the predetermined dynamic effect may be spreading flowers or blooming fireworks and so on.

For example, the predetermined condition is the distance between display positions is greater than ten pixel points and less than twenty pixel points, and the two layers for the picture 1 is the second layer and the third layer. On the basis of the display position of the picture main scenario element 20 to be displayed on the second layer and the display position of the picture text element 30 to be displayed on the third layer, the relative relationship between the picture main scenario element 20 and the picture text element 30 is determined. If the distance between display positions is greater than ten pixel points and less than twenty pixel points, a picture of the golden hoop is generated at a predetermined position of a head of the cartoon character picture of Monkey King.

According to the picture displaying method provided in the embodiment, the picture background element, the picture main scenario element and the picture text element and so on are displayed on a plurality of layers respectively, and the layer with a higher priority corresponds to a smaller movement speed. With the above technical solution, the picture is displayed in a staggered manner, the movement effect of the picture is enriched, interaction with user is increased, and the picture elements displayed on the layer with higher priority can stay in the visual field of the user for a longer time, thereby attracting more attention of the user and highlighting the important picture elements of the picture. In addition, in a case that the relative relationship of two picture elements conforms to the predetermined condition, the predetermined dynamic effect can be generated, thereby further enriching the picture display effect.

### Third Embodiment

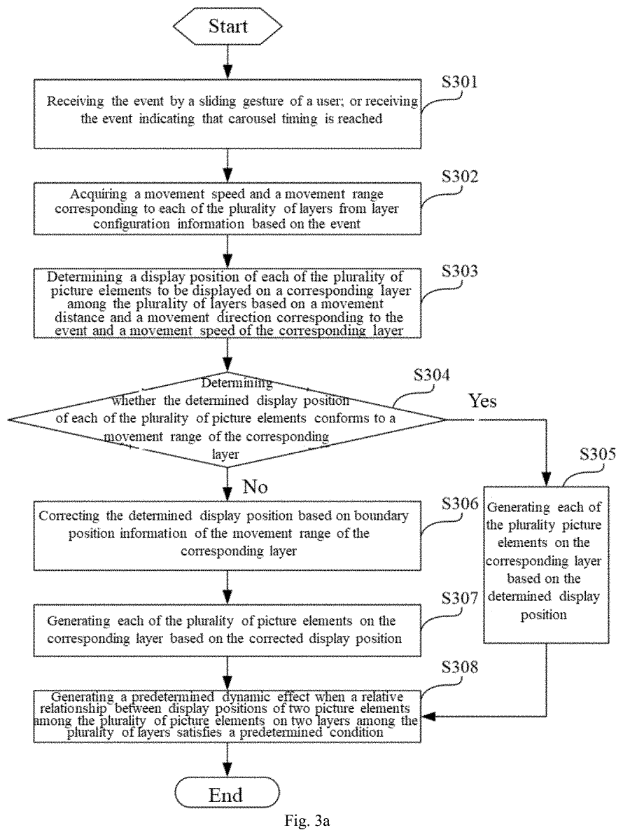

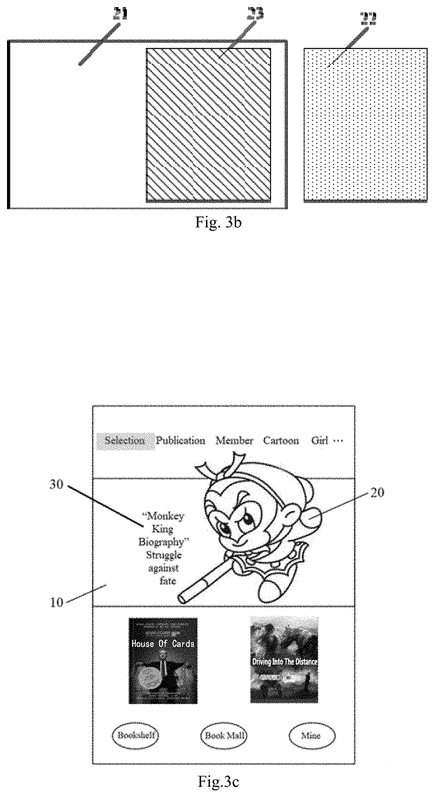

FIG. 3a is a schematic flowchart of a picture displaying method according to a third embodiment of the present disclosure. As shown in FIG. 3a, the method includes steps S301 to S308 in the following.

Step S301, receiving the event by a sliding gesture of a user; or receiving the event indicating that a carousel timing is reached.

A plurality of pictures which can be displayed circularly are provided at a position such as top of each classification page in the electronic book client, for displaying content which is expected to be seen first by the user in the classification page. The picture may include at least one of a picture background element displayed on a first layer, a picture main scenario element displayed on a second layer and a picture text element displayed on a third layer. In order to highlight the picture main scenario element, a display height of the picture main scenario element may be greater than a display height of the picture background element, thereby obtaining a better stereoscopic display effect.

For example, a plurality of pictures which can be displayed circularly are provided at the top of the selection page of the electronic book client. One picture is picture 1 for displaying promotional content of an electronic book “Monkey King Biography”. The picture 1 includes a picture background element 10 displayed on the first layer, a picture main scenario element 20 displayed on the second layer and a picture text element 30 displayed on a third layer. FIG. 2b shows a schematic diagram of initial displaying of the picture 1 in the electronic book client.

The plurality of pictures can be moved in response to a sliding gesture of the user or carousel. Specifically, in step S301, a event by a sliding gesture of a user is received; or a event indicating that a carousel timing is reached is received.

Step S302, acquiring a movement speed and a movement range corresponding to each of the plurality of layers from layer configuration information based on the event.

The layer configuration information includes specific content of picture elements corresponding to each layer respectively, initial display position of the picture elements, a movement speed and a movement range, etc. Based on the event, the movement speed and the movement range corresponding to each layer are acquired from the layer configuration information. In the embodiment, different layers correspond to a same movement speed; and a layer with a higher priority corresponds to a smaller movement range, so that the picture elements displayed on the layer with the higher priority can stay in the visual field of the user for a longer time, thereby attracting more attention of the user.

In an actual application, the priority of the second layer is higher than the priority of the third layer, and the priority of the third layer is higher than the priority of the first layer. Therefore, a movement range corresponding to the second layer is less than a movement range corresponding to the third layer, and the movement range corresponding to third layer is less than a movement range corresponding to the first layer, so that the picture main scenario element displayed on the second layer can stay in the visual field of the user for a longer time, so as to attract attention of the user on the picture main scenario element, thereby realizing the purpose to highlight the picture main scenario element.

In step S303, determining a display position of each of the plurality of picture elements to be displayed on a corresponding layer among the plurality of layers based on a movement distance and a movement direction corresponding to the event and a movement speed of the corresponding layer.

Specifically, based on the movement distance and the movement direction corresponding to the event and the movement speed of each layer, a movement distance of the picture elements to be displayed on each layer in a movement direction corresponding to the event is determined first. Then, display position of the picture elements to be displayed on each layer respectively is determined based on the movement distance of the picture elements to be displayed on each layer and initial display position of the picture elements. If all layers correspond to a same movement speed, the determined movement distances of the picture elements to be displayed on the each layer in the movement direction corresponding to the event are the same.

Step S304, determining whether the determined display position of each of the plurality of picture elements conforms to a movement range of the corresponding layer; step S305 is performed when the determined display position conforms to the movement range of the corresponding lay; and step S306 is performed when the determined display position does not conform to the movement range of the corresponding layer.

Since respective layers correspond to different movement ranges, after the display position of the picture element to be displayed on each layer is determined, it is still required to determine whether the determined display position of each of the plurality of picture elements conforms to a movement range of the corresponding layer. when the determined display position conforms to the movement range of the corresponding lay, it is indicated that a display region corresponding to the display position does not go beyond the movement range of the corresponding layer, and step S305 is performed. If the determined display position does not conform to the movement range of the corresponding lay, it is indicated that the display region corresponding to the display position goes beyond the movement range of the corresponding layer, step S306 is performed.

Step S305, generating each of the plurality picture elements on the corresponding layer based on the determined display position.

When the determined display position conforms to the movement range of the corresponding layer, corresponding picture elements may be generated on the corresponding layer based on the display position of corresponding picture element. Specifically, corresponding picture element is generated in a display region corresponding to the display position.

Step S306, correcting the determined display position based on boundary position information of the movement range of the corresponding layer.

When the determined display position conforms to the movement range of the corresponding lay, it is indicated that a display region corresponding to the determined display position goes beyond the movement range of the corresponding layer. In this case, the determined display position is required to be corrected based on boundary position information of the movement range of the corresponding layer. Specifically, the display position is corrected to be within the movement range.

Step S307, generating each of the plurality of picture elements on the corresponding layer based on the corrected display position.

FIG. 3b is a schematic diagram showing the display region corresponding to display position of the picture main scenario element 20 to be displayed on the second layer determined for the picture 1, and a movement range corresponding to the second layer. In FIG. 3b, the movement range corresponding to the second layer is marked by a frame 21. The display region corresponding to the determined display position of the picture main scenario element 20 to be displayed on the second layer is marked by a frame 22. As shown in FIG. 3b, the determined display position of the picture main scenario element to be displayed on the second layer does not conform to the movement range corresponding to the second layer, the determined display position of the picture main scenario element 20 to be displayed on the second layer is required to be corrected. In FIG. 3b, a display region corresponding to the corrected display position of the picture main scenario element 20 to be displayed on the second layer is marked by a frame 23. FIG. 3c shows a schematic diagram of staggered displaying of the generated picture 1.

Since respective layers correspond to different movement ranges, display regions of picture elements of different layers may overlap with each other. In a case that the display regions of the picture elements of any two layers overlap with each other, picture elements of a layer with a higher priority are generated above the picture element of a layer with a lower priority, thereby displaying the picture elements of the layer with the higher priority to the user with a priority.

Step S308, generating a predetermined dynamic effect when a relative relationship between display positions of two picture elements among the plurality of picture elements on two layers among the plurality of layers satisfies a predetermined condition.

Specifically, based on display position of the picture elements to be displayed on two specified layers, the relative relationship between the picture elements of two specified layers is determined. Then, a predetermined dynamic effect is generated in a case that the relative relationship between the picture elements of two specified layers conforms the predetermined condition, to further enrich the picture display effect. The predetermined dynamic effect may be spreading flowers or blooming fireworks and so on.

With the picture displaying method according to the embodiment, the picture background element, the picture main scenario element and the picture text element and so on are displayed on a plurality of layers respectively, and the layer with a higher priority corresponds to a smaller movement range. With the above technical solution, the picture is displayed in a staggered manner, the movement effect of the picture is enriched, interaction with user is increased, and the picture elements displayed on the layer with higher priority can stay in the visual field of the user for a longer time; thereby attracting more attention of the user and highlighting the important picture elements of the picture. In addition, in a case that the relative relationship of two picture elements conforms to the predetermined condition, the predetermined dynamic effect can be generated, thereby further enriching the picture display effect.

### Fourth Embodiment

A non-volatile computer readable storage medium is provided according to a fourth embodiment of the present disclosure. The non-volatile computer readable storage medium stores at least one executable instruction. The executable instruction is executed to perform the picture displaying method according to any method embodiment above.

The executable instruction may cause a processor to perform operations of: receiving an event of triggering a movement of a picture, wherein the picture includes a plurality of picture elements displayed on a plurality of layers, respectively; acquiring at least one movement parameter corresponding to each of the plurality of layers based on the event, wherein at least one movement parameter corresponding to at least one of the plurality of layers differs from at least one movement parameter corresponding to any other layer among the plurality of layers; and generating the plurality of picture elements on the plurality of layers based on a plurality of movement parameters corresponding to the plurality of layers, respectively, in response to the event.

In an optional embodiment, the executable instruction causes the processor to perform operations of: receiving the event by a sliding gesture of a user; or receiving the event indicating that a carousel timing is reached.

In an optional embodiment, the executable instruction causes the processor to perform operations of: acquiring a movement speed corresponding to each of the plurality of layers from layer configuration information based on the event, wherein a layer with a higher priority corresponds to a smaller movement speed.

In an optional embodiment, the executable instruction causes the processor to perform operations of: determining a display position of each of the plurality of picture elements to be displayed on a corresponding layer among the plurality of layers based on a movement distance and a movement direction corresponding to the event and a movement speed of the corresponding layer; and generating each of the plurality picture elements on the corresponding layer based on a corresponding determined display position.

In an optional embodiment, the executable instruction causes the processor to perform operations of: acquiring a movement speed and a movement range corresponding to each of the plurality of layers from the layer configuration information based on the event, wherein each of the plurality of layers correspond to a same movement speed, and a layer with a higher priority corresponds to a smaller movement range.

In an optional embodiment, the executable instruction causes the processor to perform operations of: determining a display position of each of the plurality of picture elements to be displayed on a corresponding layer among the plurality of layers based on a movement distance and a movement direction corresponding to the event and a movement speed of the corresponding layer; determining whether the determined display position of each of the plurality of picture elements conforms to a movement range of the corresponding layer; when the determined display position conforms to the movement range of the corresponding lay, generating each of the plurality of picture elements on the corresponding layer based on the determined display position; and when the determined display position does not conform to the movement range of the corresponding layer, correcting the determined display position based on boundary position information of the movement range of the corresponding layer, and generating each of the plurality of picture elements on the corresponding layer based on the corrected display position.

In an optional embodiment, the executable instruction causes the processor to perform operations of: overlaying a first picture element on a first layer with a higher priority above a second picture element on a second layer with a lower priority when there is an overlap between display regions of the first picture element and the second picture element, wherein the first picture element and the second picture element are among the plurality of picture elements, the first layer and the second layer are among the plurality of layers.

In an optional embodiment, the executable instruction causes the processor to perform operations of: generating a predetermined dynamic effect when a relative relationship between display positions of two picture elements among the plurality of picture elements on two layers among the plurality of layers satisfies a predetermined condition.

In an optional embodiment, the picture includes at least one of a picture background element on a first layer, a picture main scenario element on a second layer, and a picture text element on a third layer.

In an optional embodiment, a display height of the picture main scenario element is greater than a display height of the picture background element.

### Fifth Embodiment

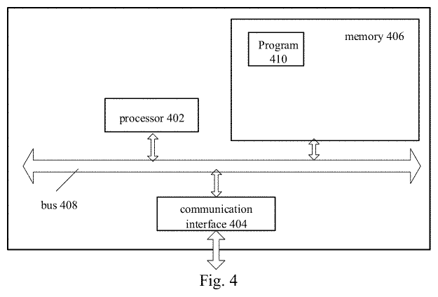

FIG. 4 is a schematic structural diagram of an electronic device according to a fifth embodiment of the present disclosure. Implementations of the electronic device are not limited by embodiments of the present disclosure.

As shown in FIG. 4, the electronic device may include: a processor 402, a communication interface 404, a memory 406 and a communication bus 408.

The processor 402, the communication interface 404, and the memory 406 communicate with each other via the communication bus 408.

The communication interface 404 is configured to perform network element communication with other device such as a client or another server.

The processor 402 is configured to perform a program 410 to perform related steps in embodiments of the picture displaying method.

Specifically, the program 410 may include a program code including a computer operation instruction.

The processor 402 may be a central processing unit CPU or an Application Specific Integrated Circuit (ASIC), or one or more integrated circuits configured to implement the embodiments of the present disclosure. The one or more processors included in the electronic device may be processors of the same type, such as one or more CPUs; or may be processors of different types, such as one or more CPUs and one or more ASICs.

The memory 406 is configured to store a program 410. The memory 406 may include a high RAM memory, or may include a non-volatile memory, such as at least one magnetic disk memory.

The program 410 may cause the processor 402 to perform the following operations of: receiving an event of triggering a movement of a picture, wherein the picture includes a plurality of picture elements displayed on a plurality of layers, respectively; acquiring at least one movement parameter corresponding to each of the plurality of layers based on the event, wherein at least one movement parameter corresponding to at least one of the plurality of layers differs from at least one movement parameter corresponding to any other layer among the plurality of layers; and generating the plurality of picture elements on the plurality of layers based on a plurality of movement parameters corresponding to the plurality of layers, respectively, in response to the event.

In an optional embodiment, the program 410 causes the processor 402 to perform the following operations of: receiving the event by a sliding gesture of a user; or receiving the event indicating that a carousel timing is reached.

In an optional embodiment, the program 410 causes the processor 402 to perform the following operations of: acquiring a movement speed corresponding to each of the plurality of layers from layer configuration information based on the event, wherein a layer with a higher priority corresponds to a smaller movement speed.

In an optional embodiment, the program 410 causes the processor 402 to perform the following operations of: determining a display position of each of the plurality of picture elements to be displayed on a corresponding layer among the plurality of layers based on a movement distance and a movement direction corresponding to the event and a movement speed of the corresponding layer; and generating each of the plurality picture elements on the corresponding layer based on a corresponding determined display position.

In an optional embodiment, the program 410 causes the processor 402 to perform the following operations of: acquiring a movement speed and a movement range corresponding to each of the plurality of layers from the layer configuration information based on the event, wherein each of the plurality of layers correspond to a same movement speed, and a layer with a higher priority corresponds to a smaller movement range.

In an optional embodiment, the program 410 causes the processor 402 to perform the following operations of: determining a display position of each of the plurality of picture elements to be displayed on a corresponding layer among the plurality of layers based on a movement distance and a movement direction corresponding to the event and a movement speed of the corresponding layer; determining whether the determined display position of each of the plurality of picture elements conforms to a movement range of the corresponding layer; when the determined display position conforms to the movement range of the corresponding lay, generating each of the plurality of picture elements on the corresponding layer based on the determined display position; and when the determined display position does not conform to the movement range of the corresponding layer, correcting the determined display position based on boundary position information of the movement range of the corresponding layer, and generating each of the plurality of picture elements on the corresponding layer based on the corrected display position.

In an optional embodiment, the program 410 causes the processor 402 to perform the following operations of: overlaying a first picture element on a first layer with a higher priority above a second picture element on a second layer with a lower priority when there is an overlap between display regions of the first picture element and the second picture element, wherein the first picture element and the second picture element are among the plurality of picture elements, the first layer and the second layer are among the plurality of layers.

In an optional embodiment, the program 410 causes the processor 402 to perform the following operations of: generating a predetermined dynamic effect when a relative relationship between display positions of two picture elements among the plurality of picture elements on two layers among the plurality of layers satisfies a predetermined condition.

In an optional embodiment, the picture includes at least one of a picture background element on a first layer, a picture main scenario element on a second layer, and a picture text element on a third layer.

In an optional embodiment, a display height of the picture main scenario element is greater than a display height of the picture background element.

For specific implementations of steps in the program 410, one may refer to description of corresponding steps in the picture displaying method according to the above embodiments, and details are not repeated herein. Those skilled in the art may clearly know that, for convenience and briefness of description, regarding the specific operation process of the device, one may refer to the description of the above method embodiments, and details are not repeated herein.

With the solution described in the embodiment of the present disclosure, corresponding picture elements are generated respectively on a plurality of layers based on the movement parameters corresponding to the layers, so that the picture is displayed in a staggered manner, and the picture movement effect is greatly enriched, thereby being beneficial to attract the attention of the user, increasing interaction with the user, and effectively improving the experience of the user

The algorithm and display described herein is not inherently related to a certain computer, virtual system or other device. Various general systems may be used together based on the teaching herein. According to the above description, structures for constructing the system are obvious. In addition, the present disclosure is not for any certain programming language. It should be understood that, the present disclosure may be implemented by various programming languages, and the above specific description is used to disclose the optimal embodiments of the present disclosure.

A large number of details are illustrated here in the specification. However, it should be understood that the embodiments of the present disclosure may be implemented without these details. In some examples, well-known methods, structures and technology are not illustrated in detail, so as not to obscure understanding of the present disclosure.

Similarly, it should be understood that, for simplifying the present disclosure and assisting understanding one or more of aspects of the present disclosure, features of the present disclosure are provided in a single embodiment, drawing or description thereof, in the description of the schematic embodiments of the present disclosure above. However, the method according to the present disclosure should not be interpreted as follows: the claimed disclosure has more features than those recited definitely in each claim. More definitely, as shown by the claims attached below, each claim recites less features than those disclosed in a single embodiment. Therefore, a claim corresponding to a certain embodiment is definitely incorporated into the embodiment, and each claim functions as a single embodiment of the present disclosure.

Those skilled in the art should understand that modules in the device of the embodiment may be changed adaptively and may be arranged in one or more devices, different from the embodiment herein. The modules, units or components in the embodiment may be combined into one module, unit or component, and the module, unit or component may be divided into multiple sub-modules, subunits or subcomponents. Unless the features or processes or units conflict with each other, all features disclosed in the specification (including the accompanying claims, abstract and drawings) and all processes or units in the method or device in the present disclosure may be combined in any manner. Unless definitely illustrated, each feature disclosed in the specification (including the accompanying claims, abstract and drawings) may be replaced with alternative features which may achieve the same, equivalent or similar object.

In addition, those skilled in the art should understand that although some embodiments described here include certain features rather than all features included in other embodiments, different embodiments can be formed by combining of features of different embodiments within the scope of the present disclosure. For example, in the following claims, the claimed embodiments may be used by combining in any manner.

It should be understood that the above embodiments are used to illustrate the present disclosure rather than limiting the present disclosure, and alternative embodiments may be designed by those skilled in the art without departing from the scope of the attached claims. In the claims, any reference symbol in the parentheses should not be constructed as limiting the claims. The term “comprising” does not preclude elements or steps not listed in the claims. Element defined by “a” or “an” does not preclude that there are multiple elements. The present disclosure may be implemented by hardware including several different elements and appropriate programming by means of a computer. Terms of first, second and third and so on do not represent any order. The terms may be explained as names.

1. A method of displaying pictures, comprising:
receiving an event of triggering a movement of a picture, wherein the picture includes a plurality of picture elements on a plurality of layers, respectively, and wherein different priorities are assigned to the plurality of layers;
determining a movement distance and a movement direction based on the event;
acquiring at least one movement parameter corresponding to each of the plurality of layers in response to the event, wherein at least one movement parameter corresponding to at least one of the plurality of layers differs from at least one movement parameter corresponding to any other layer among the plurality of layers;
determining a display position of each of the plurality of picture elements to be displayed on a corresponding layer after the movement of the picture based on the movement distance, the movement direction, and the at least one movement parameter corresponding to each of the plurality of layers; and
generating the plurality of picture elements on the plurality of layers, respectively, based on the determined display position of each of the plurality of picture elements.

2. The method according to claim 1, wherein the event comprises a sliding gesture of a user or an indication that a carousel timing is reached.

3. The method according to claim 1, the at least one movement parameter include a movement speed;
wherein the acquiring at least one movement parameter corresponding to each of the plurality of layers in response to the event further comprises:
acquiring the movement speed corresponding to each of the plurality of layers from layer configuration information in response to the event, wherein a layer with a higher priority corresponds to a smaller movement speed.

4. (canceled)

5. The method according to claim 1, wherein the acquiring at least one movement parameter corresponding to each of the plurality of layers in response to the event further comprises:
acquiring a movement speed and a movement range corresponding to each of the plurality of layers from the layer configuration information in response to the event, wherein each of the plurality of layers correspond to a same movement speed, and a layer with a higher priority corresponds to a smaller movement range.

6. The method according to claim 5, wherein the generating the plurality of picture elements on the plurality of layers, respectively, based on the determined display position of each of the plurality of picture elements further comprises:
determining whether the determined display position of each of the plurality of picture elements conforms to a movement range of the corresponding layer;
when the determined display position conforms to the movement range of the corresponding lay, generating each of the plurality of picture elements on the corresponding layer based on the determined display position; and
when the determined display position does not conform to the movement range of the corresponding layer, correcting the determined display position based on boundary position information of the movement range of the corresponding layer, and generating each of the plurality of picture elements on the corresponding layer based on the corrected display position.

7. The method according to claim 1, wherein the generating the plurality of picture elements on the plurality of layers, respectively, based on the determined display position of each of the plurality of picture elements further comprises:
overlaying a first picture element on a first layer with a higher priority above a second picture element on a second layer with a lower priority when there is an overlap between display regions of the first picture element and the second picture element, wherein the first picture element and the second picture element are among the plurality of picture elements, the first layer and the second layer are among the plurality of layers.

8. The method according to claim 1, wherein after the generating the plurality of picture elements on the plurality of layers, respectively, based on the determined display position of each of the plurality of picture elements, the method further comprises:
displaying a predetermined dynamic effect when a relative relationship between display positions of two picture elements among the plurality of picture elements on two corresponding layers among the plurality of layers satisfies a predetermined condition.

9. The method according to claim 1, wherein the picture comprises a picture background element, a picture main scenario element, and a picture text element on three corresponding layers.

10. The method according to claim 9, wherein a display height of the picture main scenario element is greater than a display height of the picture background element.

11. An electronic device, comprising:
at least one processor; and
at least one memory, the at least one memory storing executable instructions that upon execution cause the at least one processor to perform operations, the operations comprising:
receiving an event of triggering a movement of a picture, wherein the picture includes a plurality of picture elements displayed on a plurality of layers, respectively, and wherein different priorities are assigned to the plurality of layers;
determining a movement distance and a movement direction based on the event;
acquiring at least one movement parameter corresponding to each of the plurality of layers in response to the event, wherein at least one movement parameter corresponding to at least one of the plurality of layers differs from at least one movement parameter corresponding to any other layer among the plurality of layers;
determining a display position of each of the plurality of picture elements to be displayed on a corresponding layer after the movement of the picture based on the movement distance, the movement direction, and the at least one movement parameter corresponding to each of the plurality of layers; and
generating the plurality of picture elements on the plurality of layers, respectively, based on the determined display position of each of the plurality of picture elements.

12. The electronic device according to claim 11, wherein the event is a sliding gesture of a user or an indication that a carousel timing is reached.

13. The electronic device according to claim 11, wherein the operations further comprise:
acquiring a movement speed corresponding to each of the plurality of layers from layer configuration information in response to the event, wherein a layer with a higher priority corresponds to a smaller movement speed.

14. (canceled)

15. The electronic device according to claim 11, wherein the operations further comprise:
acquiring a movement speed and a movement range corresponding to each of the plurality of layers from the layer configuration information in response to the event, wherein each of the plurality of layers correspond to a same movement speed, and a layer with a higher priority corresponds to a smaller movement range.

16. The electronic device according to claim 15, wherein the operations further comprise:
determining whether the determined display position of each of the plurality of picture elements conforms to a movement range of the corresponding layer;
when the determined display position conforms to the movement range of the corresponding lay, generating each of the plurality of picture elements on the corresponding layer based on the determined display position; and
when the determined display position does not conform to the movement range of the corresponding layer, correcting the determined display position based on boundary position information of the movement range of the corresponding layer, and generating each of the plurality of picture elements on the corresponding layer based on the corrected display position.

17. The electronic device according to claim 11, wherein the operations further comprise:
overlaying a first picture element on a first layer with a higher priority above a second picture element on a second layer with a lower priority when there is an overlap between display regions of the first picture element and the second picture element, wherein the first picture element and the second picture element are among the plurality of picture elements, the first layer and the second layer are among the plurality of layers.

18. The electronic device according to claim 11, wherein the operations further comprise:
displaying a predetermined dynamic effect when a relative relationship between display positions of two picture elements among the plurality of picture elements on two corresponding layers among the plurality of layers satisfies a predetermined condition.

19. The electronic device according to claim 11, wherein the picture comprises a picture background element, a picture main scenario element, and a picture text element on three corresponding layers.

20. The electronic device according to claim 19, wherein a display height of the picture main scenario element is greater than a display height of the picture background element.

21. A non-transitory computer readable storage medium, storing executable instructions that upon execution cause a processor to perform operations comprising:
receiving an event of triggering a movement of a picture, wherein the picture includes a plurality of picture elements displayed on a plurality of layers, respectively, and wherein different priorities are assigned to the plurality of layers;
determining a movement distance and a movement direction based on the event
acquiring at least one movement parameter corresponding to each of the plurality of layers in response to the event, wherein at least one movement parameter corresponding to at least one of the plurality of layers differs from at least one movement parameter corresponding to any other layer among the plurality of layers;
determining a display position of each of the plurality of picture elements to be displayed on a corresponding layer after the movement of the picture based on the movement distance, the movement direction, and the at least one movement parameter corresponding to each of the plurality of layers; and
generating the plurality of picture elements on the plurality of layers, respectively, based on the determined display position of each of the plurality of picture elements.

22. (canceled)

23. The non-transitory computer readable storage medium of claim 21, wherein the operations further comprise:
displaying a predetermined dynamic effect when a relative relationship between display positions of two picture elements among the plurality of picture elements on two corresponding layers among the plurality of layers satisfies a predetermined condition.
